(19) United States
(12) Patent Application Publication
(10) Pub. No.: US 2008/0070629 A1
(43) Pub. Date: Mar. 20, 2008

(54) METHOD AND MOBILE COMMUNICATION DEVICE FOR RESUMING A FUNCTIONING OF A SUBSCRIBER IDENTITY MODULE

(75) Inventor: HAN-SHENG YUAN, Jen Te (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: CHI MEI COMMUNICATION SYSTEMS, INC., Jen Te (TW)

(21) Appl. No.: 11/741,465

(22) Filed: Apr. 27, 2007

(30) Foreign Application Priority Data
Sep. 20, 2006 (CN) 200610062670.1

(51) Int. Cl. H04M 1/00

(52) U.S. Cl. 455/558

(57) ABSTRACT

A method for resuming a functioning of a subscriber identity module of a mobile communication device (e.g., cell phone or PDA) is provided, with the subscriber identity module being provided in a phone body of the communication device. The method includes a series of steps. Particularly, when the phone body determines that it has received an erroneous command/state of the SIM, the phone body resends the last command before the erroneous command/state that was received was sent (201). The phone body judges whether the resending contained any errors (203). If no errors are detected, the functions of the SIM card are resumed, and the process is ended (207). Otherwise, further steps can be performed to attempt to resume proper functioning of the SIM card.

### BACKGROUND OF THE INVENTION

1. Field of the Invention

The present invention relates to methods and devices of mobile communication and, especially, to a method and mobile communication device for resuming a functioning of a subscriber identity module.

2. Description of Related Art

A common mobile communication device, such as a mobile phone or a PDA, includes a phone body and a subscriber identity module (SIM) card used in the phone body. In a mobile communication system such as the global system for mobile communication (GSM), the identity information of the mobile phone is stored in a SIM card that can be provided by the operator. When the SIM card is used in the phone body, the mobile phone can be used to communicate with the mobile communication system via the SIM card.

Sometimes, when the mobile phone is working, a function of the SIM card may be invalidated because of static electricity, poor connection, mechanical impact (e.g., dropped), electrical short, and/or other factors. In this case, the phone body cannot control the SIM card and cannot read or write data with the SIM card, thus creating problems for the mobile phone subscriber.

What is needed in the art is a method of resuming appropriate operation of a SIM card after one or more functions thereof has become invalidated and/or inoperative.

### SUMMARY

In one aspect thereof, a method for resuming a functioning of a subscriber identity module (SIM) card of a mobile communication device includes the following steps. When the phone body determines that it has received an erroneous command/state from the SIM, the phone body resends the last command that was sent before the erroneous command/state that was received was sent. The phone body judges whether the resending of the last command to be sent before the erroneous command/state that was received was sent contains any errors; and, if no errors are detected, the functions of the SIM card are resumed.

Other advantages and novel features of the present invention will become more apparent from the following detailed description of preferred embodiment when taken in conjunction with the accompanying drawings.

### BRIEF DESCRIPTION OF THE DRAWINGS

Many aspects of the present method for resuming a functioning of a subscriber identity module of a mobile communication device can be better understood with reference to the following drawings. The components in the drawings are not necessarily drawn to scale, the emphasis instead being placed upon clearly illustrating the principles of the present method. Moreover, in the drawings, like reference numerals designate corresponding parts throughout the several views.

FIG. 1 is a flow chart of a method for resuming the functions of a subscriber identity module, according to a preferred embodiment.

### DETAILED DESCRIPTION OF THE INVENTION

A mobile communication device (not shown, per se), such as a mobile phone or PDA, includes a phone body and a subscriber identity module (SIM) card used in the phone body. When the SIM card is electronically connected to the phone body and the mobile phone is powered, a personal identification number (PIN)/PIN unlock key (PUK) of the SIM card should be recorded in the phone body and used for identifying the user identity to, amongst other things, guard against the mobile phone being misappropriated. If the mobile subscriber changes the PIN of the SIM card, the PIN recorded in the phone body can be replaced with the new PIN. After receiving power, the phone body judges whether the PIN/PUK requires verification and verifies the PIN, as necessary. If the PIN/PUK does not need to be verified or if the PIN/PUK is verified, the phone body enters into a normal working state.

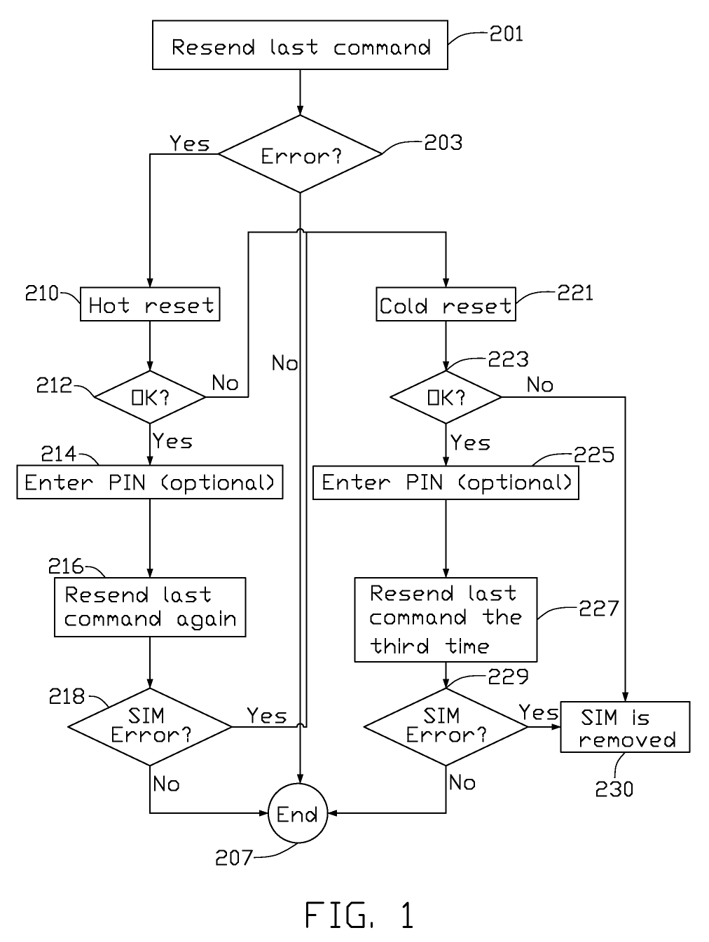

Referring to FIG. 1, when the phone body determines that it has received an erroneous command/state due to external cause, such as static electricity, poor connection, and/or some other factor, the functions of the SIM card may be resumed by carrying out the following steps. In step 201, the phone body resends the last command that was sent before the erroneous command/state that was received was sent. In step 203, the phone body judges whether the resending of the last command that was sent before the erroneous command/state that was received was sent contains any errors. If there are no errors, the functions of the SIM card are resumed (step 207), and the process is ended; if any errors are detected, step 210 is initiated.

In step 210, a hot reset (i.e., resetting the SIM card without cutting power) for the SIM card is, usefully, carried out by an intelligent system (i.e., one capable of receiving information and providing instructions in response) within the SIM card. In step 212, the phone body judges whether the hot reset is successful. If it is successful, then step 214 is initiated, according to the settings of the phone body. In particular, if the SIM card is set that the PIN/PUK needs to be verified, and then the PIN code is entered. Otherwise, if the PIN code does not need to be entered, step 214 can be omitted. Upon satisfying step 214, if needed, or omitting such if not required, step 216 can be initiated, and the phone body resends the last command again. In step 218, the phone body judges whether the second resending contains any errors. If there are no errors in the second resending, step 207 is initiated, the functions of the SIM card are resumed, and the process is ended. If, however, any error is detected in step 212 or in step 218, step 221 is initiated.

In step 221, a cold reset for the SIM card is initiated by a given device that can activate/deactivate the power of the SIM card within the phone body. In step 223, the phone body judges whether the cold reset was successful. If the cold reset is successful, step 225 can be initiated. In step 225, the PIN code, in accordance to the settings of the phone body, is entered, if the SIM card is set that the PIN/PUK needs to be verified. Otherwise, if the PIN code does not need to be entered, step 225 can be omitted. Upon satisfying step 225, if needed, or omitting such if not required, step 227 can be carried out. In step 227, the last command that was sent before the erroneous command/state that was received was sent can be resent for a third time. In step 229, the phone body judges whether the third resending contains any errors. If there are no errors, step 207 can be initiated, and the functions of the SIM card can be resumed. If any errors are detected in step 223, step 230 can be initiated. In step 230 the phone body determines that the SIM card needs to be removed and/or replaced.

In step 210 and 221, the reset device for the SIM card can be an ATR (answer to reset) program, that is, when the SIM card is started up, operational requirement parameters thereof are sent to the phone body. If required, the phone body may process a PPS (protocol and parameter select) program. The PPS program is used to inform the ATR program of the SIM card whether the operational requirement parameters need to be accepted.

The method for resuming a functioning of a subscriber identity module of a mobile communication device described above may repair the defect of the common phone body. When the functions of the SIM card are suspended, the SIM card is reset automatically without requiring the phone body to be powered off and powered on by the subscriber. Only upon failing to reset via such an algorithm is the user required to remove and/or replace the SIM card.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for resuming a functioning of a subscriber identity module (SIM), the subscriber identity module being provided in a phone body, the method comprising the following steps:
determining that an erroneous command/state has been received from the SIM, the determining step being performed by the phone body;
resending the last command that was sent before the erroneous command/state that was received was sent, the resending step being performed by the phone body;
judging whether the resending of the last command that was sent before the erroneous command/state that was received was sent contains any errors, the judging step being performed by the phone body; and
resuming the functioning of the SIM card if no errors are detected in the judging of the resending of the last command.

2. The method for resuming a functioning of a subscriber identity module as described in claim 1, wherein if the resending of the last command that was sent before the erroneous command/state that was received was sent does contain any errors, the following steps are performed before the process is ended:
carrying out a hot reset for the SIM card;
judging whether the hot reset is successful, the judging of the hot reset being accomplished by the phone body;
resending the last command that was sent before the erroneous command/state that was received was sent again, if the hot reset is successful; and
judging whether the second resending contained any errors, the judging of the second resending being performed by the phone body; and
resuming the functioning of the SIM card is resumed, if no errors are detected in the judging of the second resending.

3. The method for resuming a functioning of a subscriber identity module as described in claim 2, wherein if the hot reset fails or if the second resending of the last command that was sent before the erroneous command/state that was received was sent contains any errors, the following steps are performed by the phone body before the process is ended:
carrying out a cold reset for the SIM card;
judging whether the cold reset is successful;
resending the last command for a third time, if the cold reset is successful;
judging whether the third resending contains any errors; and
resuming the functions of the SIM card, if there are no errors in the third resending.

4. The method for resuming a functioning of a subscriber identity module as described in claim 3, wherein if the cold reset has failed or if the third resending of the last command that was sent before the erroneous command/state that was received was sent contains any errors, the phone body determines that the SIM card needs to be removed or replaced.

5. The method for resuming a functioning of a subscriber identity module as described in claim 2, there is a personal identification number (PIN)/personal identification number unlock key (PUK) of the SIM card recorded in the phone body, and the phone body judges whether the PIN/PUK requires verification and verifies the PIN as necessary.

6. The method for resuming a functioning of a subscriber identity module as described in claim 5, wherein after judging whether the second resending of the last command that was sent before the erroneous command/state that was received was sent, the method further includes a step of entering the PIN.

7. The method for resuming a functioning of a subscriber identity module as described in claim 3, wherein the phone body judges whether a personal identification number (PIN)/personal identification number unlock key (PUK) of the SIM card recorded in the phone body requires verification and verifies the PIN as necessary.

8. The method for resuming a functioning of a subscriber identity module as described in claim 7, wherein before the third resending of the last command that was sent before the erroneous command/state that was received was sent, the method further includes a step of entering the PIN.
